(19) United States
(12) Patent Application Publication
(10) Pub. No.: US 2015/0147904 A1
(43) Pub. Date: May 28, 2015

(54) CONNECTOR STRUCTURE

(71) Applicant: YAZAKI CORPORATION, Tokyo (JP)

(72) Inventor: Kenji Takahashi, Shizuoka (JP)

(21) Appl. No.: 14/402,217

(22) PCT Filed: Jul. 2, 2013
(86) PCT No.: PCT/JP2013/068120

§ 371 Date: Nov. 19, 2014

(30) Foreign Application Priority Data
Jul. 2, 2012 (JP) 2012-148112

(51) Int. Cl. H01R 13/642; H01R 13/52

(52) U.S. Cl. CPC H01R 13/642; H01R 13/5216
USPC 439/380

(57) ABSTRACT

In a base part 25 of a male connector housing 22, surfaces 25a and 25b where adjacent terminals 23 and 23 are installed upright are formed at mutually different levels to form a step 24 between the surfaces 25a and 25b. In a fitting tip surface 21 of a female connector housing 13, surfaces 21a and 21b where adjacent terminal accommodation chambers 17 and 17 are formed are formed at mutually different levels to form a step 20 between the surfaces 21a and 21b.

### TECHNICAL FIELD

The present invention relates to a connector structure.

### BACKGROUND ART

Various kinds of electronic equipments are mounted on an automobile. Further, in the automobile, wire harnesses are arranged for transmitting electric power, control signals, and the like to the electronic equipments. Such a wire harness is provided with a plurality of electric wires and connectors attached to the terminal ends of these electric wires. Such a connector includes: terminal fittings electrically connected to the terminal ends of the electric wires; and a connector housing in which terminal accommodation chambers for accommodating these terminal fittings are formed.

However, in some cases, a connector having the above-mentioned configuration is used in lubricating oil in an automatic transmission. Then, in the lubricating oil in the automatic transmission, dust particles such as metal powder formed by wear of gear wheels are floating. Further, in the connector, an entering route permitting entrance of dust particles in the lubricating oil is formed in association with functional requirements or requirements concerning molding properties in resin molding. Thus, there has been a possibility that dust particles having entered the connector housing through the entering route adhere over a plurality of the terminal fittings so as to cause a short circuit between the terminals.

Patent Literatures 1 to 3 are known as solutions of such a problem.

Sections (a) to (c) of FIG. 9 show a connector structure in Patent Literature 1. Section (a) of FIG. 9 is a partially omitted sectional view of a female connector 1. Section (b) of FIG. 9 is a partially omitted front view in which the female connector 1 is viewed from the fitting-direction tip side. Section (c) of FIG. 9 is a partially omitted sectional view of a male connector 2. As shown in Sections (a) to (c) of FIG. 9, in Patent Literature 1, grooves 3 are provided in the connector fitting surface of a male connector 2 while protrusions 4 are provided in the connector fitting surface of a female connector 1 so that countermeasures are taken against a short circuit between the terminals caused by dust particles. That is, when connector fitting has been performed, depression and protrusion shapes (the depression and protrusion shapes formed by the grooves 3 and the protrusions 4) are fit in each other so that a creepage distance is made large and hence resolves the problem of occurrence of a short circuit between the terminals caused by dust particle inclusion during usage in oil.

### CITATION LIST

### Patent Literature

Patent Literature 1: JP-A-2010-27507

Patent Literature 2: JP-A-2011-165370

Patent Literature 3: JP-A-2007-115614

### SUMMARY

### Technical Problem

However, like in the above-mentioned Patent Literature 1, when the grooves 3 are provided between the terminals of the male connector 2 while the protrusions 4 are provided between the terminals of the female connector 1 and then they are fit in each other along the depression and protrusion shapes formed by the grooves 3 and the protrusions 4, the pitch between the terminals need be expanded than in an ordinary connector in order to ensure the shape of the protrusion 4. Thus, the expansion in the pitch between the terminals has caused size increase in the connector external appearance shape.

An object of the present invention is to provide a connector structure in which a short circuit between terminals caused by entering of dust particles is suppressed and size increase in the connector is suppressed.

### Solution to Problem

The present invention has been devised in view of the above-mentioned problem.

(1) A connector structure includes: a female connector including a female connector housing in which a plurality of terminal accommodation chambers for respectively accommodating a plurality of terminal fittings are aligned; and a male connector including a male connector housing provided with a base part in which a plurality of terminals are installed upright and with a side wall installed upright from a side edge of the base part, wherein when the female connector housing is fit in the male connector housing so that a fitting tip surface of the female connector housing abuts against the base part of the male connector housing, the plurality of terminals are respectively inserted into the plurality of terminal fittings to establish electric connection, and wherein: in the base part of the male connector housing, surfaces where the adjacent terminals are installed upright are formed at mutually different levels to form a step between the surfaces where the adjacent terminals are installed upright; and in the fitting tip surface of the female connector housing, surfaces where the adjacent terminal accommodation chambers are formed at mutually different levels to form a step between the surfaces where the adjacent terminal accommodation chambers are formed.

### BRIEF DESCRIPTION OF DRAWINGS

FIG. 1 Section (a) of FIG. 1 is a perspective view showing a structure of a female connector in an embodiment of the present invention; Section (b) of FIG. 1 is a front view in which the female connector shown in Section (a) of FIG. 1 is viewed from the fitting-direction tip side; and Section (c) of FIG. 1 is a sectional view taken along line I-I in Section (b) of FIG. 1.

FIG. 2 Section (a) of FIG. 2 is a sectional view taken along line II-II in Section (b) of FIG. 1; and Section (b) of FIG. 2 is a main-part expansion sectional view of Section (a) of FIG. 2.

FIG. 3 Section (a) of FIG. 3 is a perspective view showing a structure of a male connector in an embodiment of the present invention; Section (b) of FIG. 3 is a front view in which the male connector shown in Section (a) of FIG. 3 is viewed from the fitting-direction tip side; and Section (c) of FIG. 3 is a sectional view taken along line III-III in Section (b) of FIG. 3.

FIG. 4 is a sectional view taken along line IV-IV in Section (b) of FIG. 3.

FIG. 5 Section (a) of FIG. 5 is a rear view in which the fitting state of a connector structure in an embodiment of the present invention is viewed from the fitting-direction tip side of the male connector; and Section (b) of FIG. 5 is a sectional view taken along line V-V in Section (a) of FIG. 5.

FIG. 6 Section (a) of FIG. 6 is a sectional view taken along line VI-VI in Section (a) of FIG. 5; and Section (b) of FIG. 6 is a main-part expansion sectional view of Section (a) of FIG. 6.

FIG. 7 Section (a) of FIG. 7 is a main part sectional view showing a creepage distance of a connector structure of a related art where countermeasures against dust particles are not taken; Section (b) of FIG. 7 is a main part sectional view showing a creepage distance of a connector structure of a related art where countermeasures against dust particles are taken; and Section (c) of FIG. 7 is a main part sectional view showing a creepage distance of the connector structure in the present embodiment.

FIG. 8 Section (a) of FIG. 8 is a main part sectional view showing a terminal-to-terminal distance of the connector structure of the related art where countermeasures against dust particles are not taken; Section (b) of FIG. 8 is a main part sectional view showing a terminal-to-terminal distance of the connector structure of the related art where countermeasures against dust particles are taken; and Section (c) of FIG. 8 is a main part sectional view showing a terminal-to-terminal distance of the connector structure in the present embodiment.

FIG. 9 Sections (a) to (c) of FIG. 9 show a connector structure of a related art; Section (a) of FIG. 9 is a partially omitted sectional view of a female connector; Section (b) of FIG. 9 is a partially omitted front view in which the female connector is viewed from the fitting-direction tip side; and Section (c) of FIG. 9 is a partially omitted sectional view of a male connector.

### DESCRIPTION OF EMBODIMENT

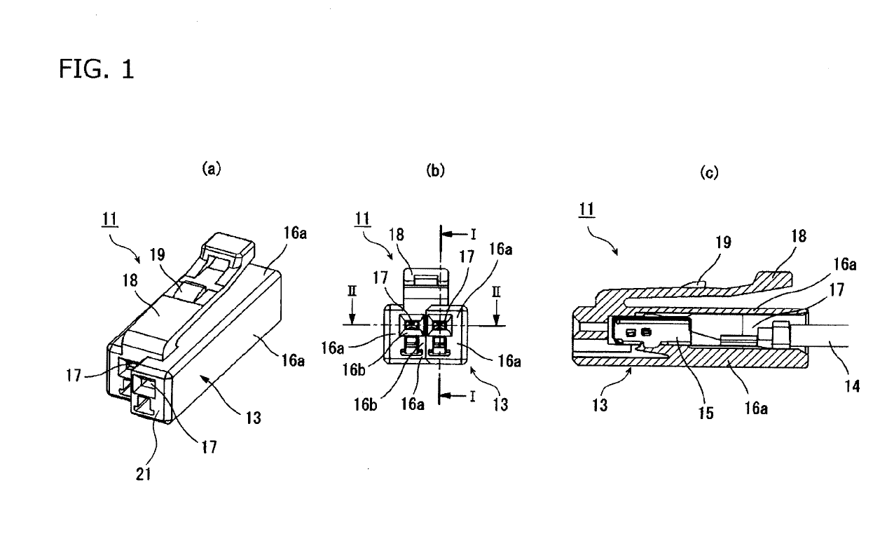

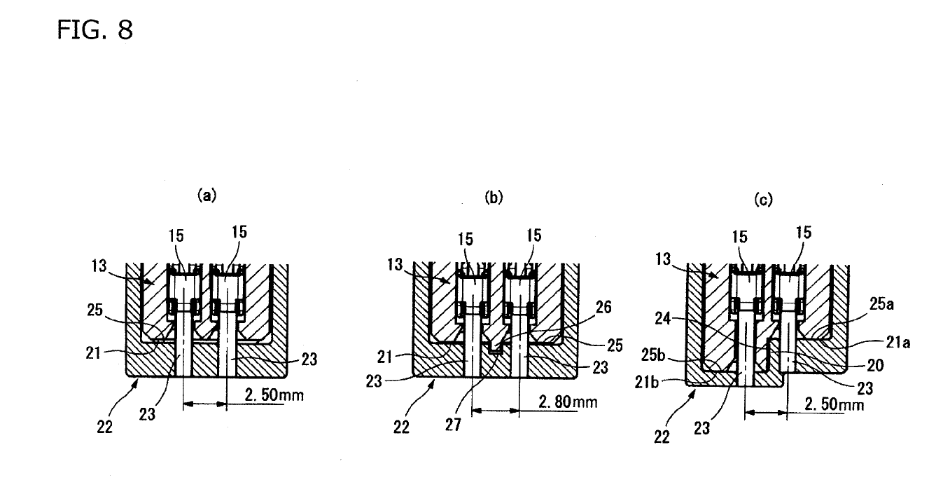

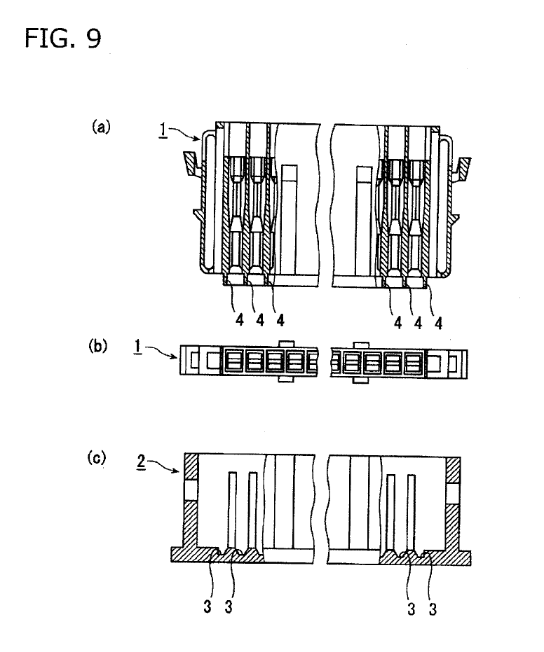

A connector structure in an embodiment of the present invention is described below in detail with reference to Section (a) of FIG. 1 to Section (c) of FIG. 8.

The connector structure in the present embodiment includes a female connector 11 and a male connector 12 serving as structural elements. Then, when the female connector 11 is housing-fitted to the male connector 12, terminal fittings 15 of the female connector 11 and the terminals 23 of the male connector 12 are electrically connected to each other.

As shown in Sections (a) to (c) of FIG. 1, the female connector 11 in the present embodiment includes a female connector housing 13 and terminal fittings 15.

The terminal fitting 15 is formed by bending an electrically conductive sheet metal or the like and then attached to an end part or the like of an electric wire constituting a wire harness 14.

The female connector housing 13 is fabricated from synthetic resin and its vertical cross section is formed in an approximately rectangular shape by four outer walls 16a. In the female connector housing 13, a plurality of terminal accommodation chambers 17 are formed on the inner side and a lock arm 18 for locking with the male connector 12 serving as counterpart is provided on the outer side.

The terminal accommodation chambers 17 are formed in tubular shapes by the outer walls 16a of the female connector housing 13 and by partitions 16b for dividing the inside of the female connector housing 13. The plurality of terminal accommodation chambers 17 are parallelly aligned and respectively accommodate the terminal fittings 15 described above in the inside thereof. In the present embodiment, two terminal accommodation chambers 17 are formed in the female connector housing 13.

The lock arm 18 is formed integratedly with the outer wall 16a and formed in a cantilever manner that one end part thereof continues to the outer wall 16a. In the lock arm 18, a lock projection part 19 is formed that protrudes to the outward of the female connector housing 13.

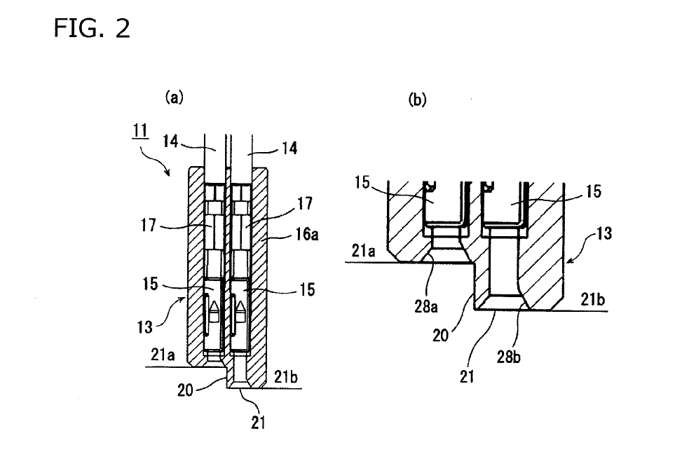

As shown in Sections (a) and (b) of FIG. 2, in the female connector 11 in the present embodiment, a step (an upright portion of the step) 20 is formed in the fitting tip surface (the surface of fitting with the male connector 12 on the fitting-direction tip side) 21. That is, in the fitting tip surface 21 of the female connector 11, surfaces 21a and 21b where the adjacent terminal accommodation chambers 17 and 17 are formed are formed at mutually different levels so that the surface 21b protrudes toward the fitting-direction tip side (downward in Section (a) of FIG. 2) relative to the surface 21a.

In the terminal accommodation chambers 17, terminal collection parts 28a and 28b are formed, where the distance between the surface 21b and the terminal fitting 15 is designed to be larger than the distance between the surface 21a and the terminal fitting 15.

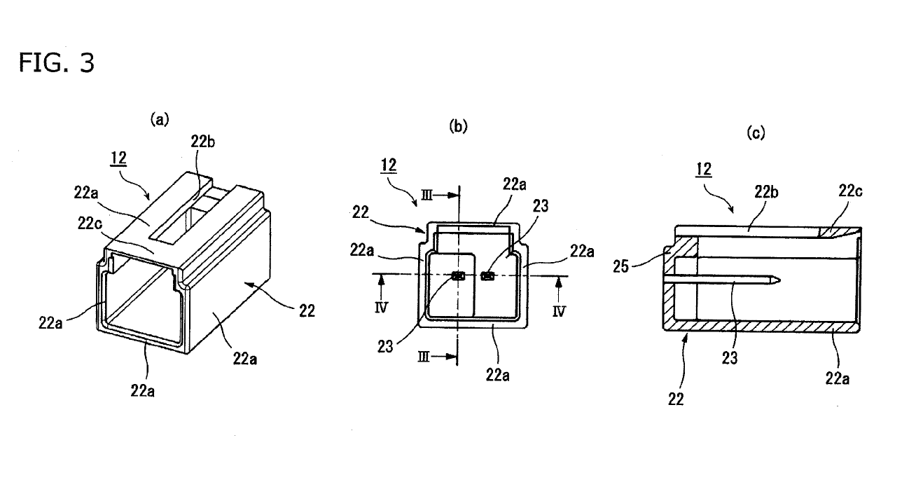

As shown in Sections (a) to (c) of FIG. 3, the male connector 12 in the present embodiment includes a male connector housing 22 and terminals 23 accommodated in the male connector housing 22.

The male connector housing 22 is formed by a base part 25 and side walls 22a installed upright from the outer edge of the base part 25. In one surface of the side walls 22a, a notch 22b is formed that has a slightly larger width than the width of the lock projection part 19 of the female connector 11. Then, on the free end side of the side wall 22a in the notch 22b, a lock receptacle part 22c is formed that engages with the lock projection part 19 of the female connector housing 13. The terminals 23 in a plurality are installed upright from the base part 25 of the male connector housing 22.

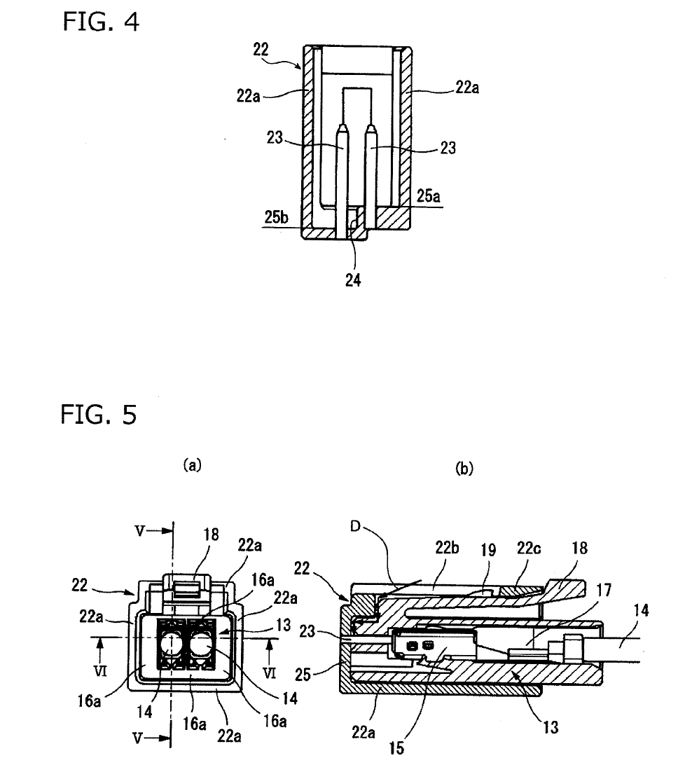

Further, in the base part 25 of the male connector housing 22, as shown in FIG. 4, a step (an upright portion of the step) 24 is formed. That is, in the base part 25 of the male connector 12, a surface 25a and a surface 25b where the adjacent terminals 23 and 23 are installed upright are formed at mutually different levels so that the surface 25a protrudes toward the fitting-direction tip side (upward in FIG. 4) relative to the surface 25b.

As shown in Sections (a) and (b) of FIG. 5, when the female connector housing 13 is fit in the male connector housing 22, the terminals 23 of the male connector 12 are inserted into the terminal fittings 15 of the female connector 11 so that the female connector 11 and the male connector 12 are electrically connected to each other.

Further, when the female connector housing 13 is brought into fit in the male connector housing 22, the lock arm 18 of the female connector bends to the inward of the female connector housing 13 so that the lock projection part 19 engages with the lock receptacle part 22c of the male connector housing 22. As such, the fitting lock mechanism constructed from the lock projection part 19 and the lock receptacle part 22c permits lock of the housing fit between both of the male and female connectors 11 and 12. This provides high stability in the electric connection between the terminal fittings 15 and the terminals 23.

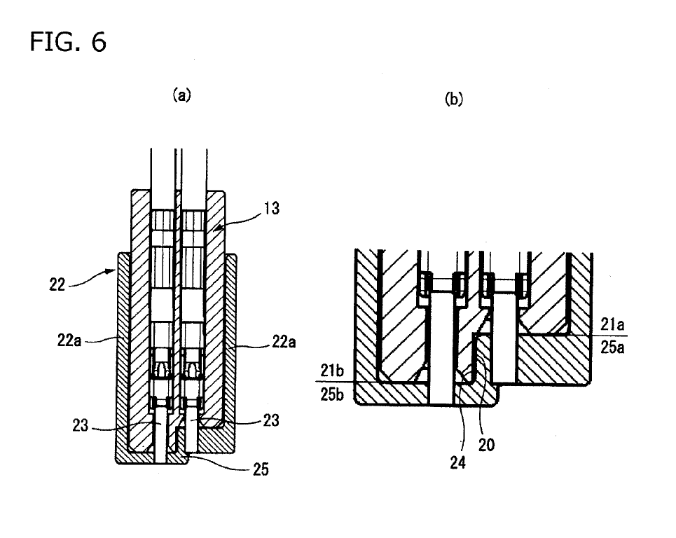

Further, as shown in Sections (a) and (b) of FIG. 6, when the female connector housing 13 is fit in the male connector housing 22, the step 20 of the female connector housing 13 and the step 24 of the male connector housing 22, the surface 21b and the surface 25b, and the surface 21a and the surface 25a respectively abut against each other.

In the case of the connector structure of the present embodiment, as indicated by an arrow D in Section (b) of FIG. 5, dust particles enter the male connector housing 22 through the notch 22b, then pass a gap between the male connector housing 22 and the female connector housing 13, and then adhere to the terminal fitting 15 and the terminal 23.

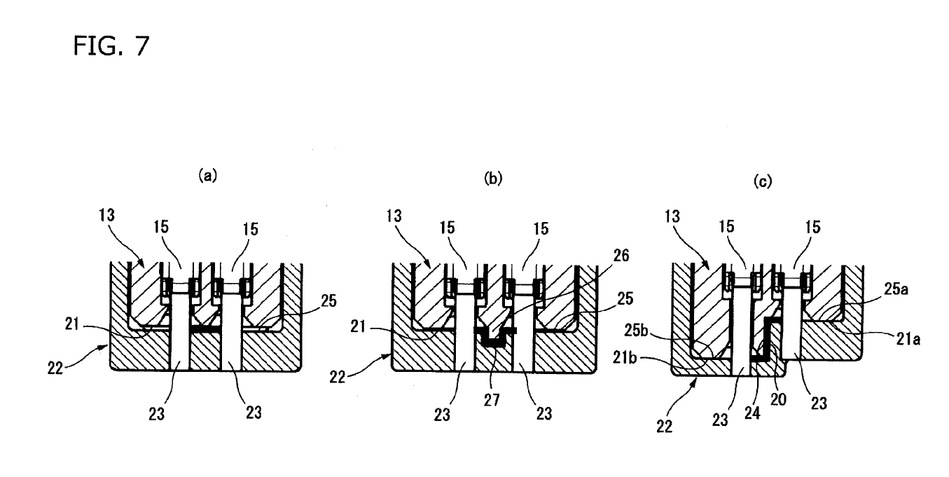

Next, the operation and effects of the connector structure in the present embodiment are described below with reference to Sections (a) to (c) of FIG. 7.

In the case of a connector structure of a related art shown in Section (a) of FIG. 7, countermeasures against dust particles are not taken and hence the base part 25 of the male connector housing 22 and the fitting tip surface 21 of the female connector housing 13 are planar. Thus, a creepage distance between the terminals 23 and 23 at the time of housing fit is short. Accordingly, when dust particles enter, the dust particles may adhere over the plurality of terminals 23 and 23 to cause a short circuit between the terminals.

In the case of a connector structure of a related art shown in Section (b) of FIG. 7, countermeasures against dust particles are taken. That is, a protrusion 26 is formed in the fitting tip surface 21 of the female connector housing 13 and a recess 27 is formed in the base part 25 of the male connector housing 22. Thus, when the female connector housing 13 is fit in the male connector housing 22, the protrusion 26 of the fitting tip surface 21 engages with the recess 27 of the base part 25 and hence depression and protrusion shapes are formed in the contact surfaces of the female connector housing 13 and the male connector housing 22 between the terminals 23 and 23. This increases a creepage distance between the terminals 23 and 23. As a result, even when dust particles enter, a situation that the dust particles adhere over the plurality of terminals 23 and 23 is suppressed and hence a short circuit between the terminals can be suppressed.

In the case of the connector structure in the present embodiment shown in Section (c) of FIG. 7, the step 20 is formed in the female connector housing 13 and the step 24 is formed in the male connector housing 22. Thus, when the female connector housing 13 is fit in the male connector housing 22, the step 20 and the step 24, the surface 21b and the surface 25b, and the surface 21a and the surface 25a respectively abut against each other and hence the creepage distance between the terminals 23 and 23 becomes large. As a result, even when dust particles enter, a situation that the dust particles adhere over the plurality of terminals 23 and 23 is suppressed and hence a short circuit between the terminals can be suppressed.

In the case of the connector structure of the related art shown in Section (a) of FIG. 8 where countermeasures against dust particles are not taken, the base part 25 of the male connector housing 22 between the terminals 23 and 23 and the fitting tip surface 21 of the female connector housing 13 are planar. Thus, no restriction is caused in a terminal-to-terminal distance in association with the shape of the fitting surface. The terminal-to-terminal distance is 2.50 mm.

In the case of the connector structure of the related art shown in Section (b) of FIG. 8 where countermeasures against dust particles are taken, the protrusion 26 is formed in the fitting tip surface 21 of the female connector housing 13 and the recess 27 is formed in the base part 25 of the male connector housing 22. In order that the shape of the protrusion 26 may be ensured in the fitting tip surface 21 of the female connector housing 13, a terminal-to-terminal distance need be increased and hence the terminal-to-terminal distance is 2.80 mm.

In the case of the connector structure in the present embodiment shown in Section (c) of FIG. 8, the step 20 is formed in the female connector housing 13 and the step 24 is formed in the male connector housing 22. However, in contrast to the connector structure of the related art shown in Section (b) of FIG. 8, the protrusion 26 is not formed. Thus, no restriction is caused in the terminal-to-terminal distance in association with the shape of the fitting surface and hence the terminal-to-terminal distance is 2.50 mm.

As described above, according to the connector structure in the present embodiment, the creepage distance between the terminals 23 and 23 can be increased. A situation that the dust particles adhere over the plurality of terminals 23 and 23 is suppressed and hence occurrence of a short circuit between the terminals can be suppressed.

Further, in comparison with the connector structure of the related art where countermeasures against dust particles are taken, the pitch dimension between the terminals can be reduced and hence size reduction in the connector external appearance shape can be achieved.

As described above, in an embodiment of the present invention, detailed description has been given only for specific examples described above. However, it is clear to the person skilled in the art that various modifications and corrections can be made within the technical scope of the present invention. Thus, obviously, such modifications and corrections are included in the scope of the claims.

For example, the embodiment given above has been described for a connector structure that the male connector 12 includes two terminals 23 and 23 and the female connector 11 includes two terminal fittings 15 and 15. Instead, numbers of the terminals 23 and the terminal fittings 15 may respectively be greater than or equal to two.

Here, the features of the embodiment of the connector according to the present invention described above are briefly listed below.

[1] The connector structure includes: the female connector 11 including the female connector housing 13 in which the plurality of terminal accommodation chambers 17 for respectively accommodating the plurality of terminal fittings 15 are parallelly aligned; and the male connector 12 including the male connector housing 22 provided with the base part 25 in which the plurality of terminals 23 are installed upright and with the side wall 22a installed upright from the side edge of the base part 25, wherein when the female connector housing 13 is fit in the male connector housing 22 so that the fitting tip surface 21 of the female connector housing 13 abuts against the base part 25 of the male connector housing 22, the plurality of terminals 23 are respectively inserted into the plurality of terminal fittings 15 to establish electric connection, and wherein: in the base part 25 of the male connector housing 22, the surfaces 25a and 25b where the adjacent terminals 23 are installed upright are formed at mutually different levels to form the step 24 between the surfaces 25a and 25b where the adjacent terminals 23 are installed upright; and in the fitting tip surface 21 of the female connector housing 13, the surfaces 21a and 21b where the adjacent terminal accommodation chambers 17 are formed are formed at mutually different levels to form the step 20 between the surfaces 21a and 21b where the adjacent terminal accommodation chambers 17 are formed.

Further, the present application is based on Japanese patent application (Patent Application No. 2012-148112) filed on Jul. 2, 2012. The contents thereof are incorporated herein by reference.

### INDUSTRIAL APPLICABILITY

According to the present invention, a connector structure can be provided in which a short circuit between terminals caused by entering of dust particles is suppressed and size increase in the connector is suppressed.

### REFERENCE SIGNS LIST

11 . . . female connector
12 . . . male connector
13 . . . female connector housing
15 . . . terminal fitting
17 . . . terminal accommodation chamber
20 . . . step
21 . . . fitting tip surface
21a, 21b . . . surface
22 . . . male connector housing
22a . . . side wall
23 . . . terminal
24 . . . step
25 . . . base part
25a, 25b . . . surface

1. A connector structure comprising:
a female connector including a female connector housing in which a plurality of terminal accommodation chambers for respectively accommodating a plurality of terminal fittings are parallelly aligned; and
a male connector including a male connector housing provided with a base part in which a plurality of terminals are installed upright and with a side wall installed upright from a side edge of the base part, wherein
when the female connector housing is fit in the male connector housing so that a fitting tip surface of the female connector housing abuts against the base part of the male connector housing, the plurality of terminals are respectively inserted into the plurality of terminal fittings to establish electric connection, and wherein:
in the base part of the male connector housing, surfaces where the adjacent terminals are installed upright are formed at mutually different levels to forma step between the surfaces where the adjacent terminals are installed upright; and
in the fitting tip surface of the female connector housing, surfaces where the adjacent terminal accommodation chambers are formed are formed at mutually different levels to forma step between the surfaces where the adjacent terminal accommodation chambers are formed.
